(19) United States
(12) Patent Application Publication
(10) Pub. No.: US 2006/0259867 A1
(43) Pub. Date: Nov. 16, 2006

(54) System and method for automatic generation of browsing favorites

(75) Inventors: Eric B. Watson, Redmond, WA (US); Kenneth A. Moss, Mercer Island, WA (US); Randall J. Macbeth, Edmonds, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/128,211

(22) Filed: May 13, 2005

(51) Int. Cl. G06F 9/00

(52) U.S. Cl. 715/760

(57) ABSTRACT

A system and related techniques monitor user navigation behavior to automatically detect candidate sites for addition to a user's browser favorites. A client machine, Internet service provider or other resource may host or execute implicit favorites logic which may detect parameters, behavior and variables indicating that a user may wish to add a Web site or other location or content to their set of browser favorites. Thus for example the navigation to a site a certain number of times a day, week or other period may indicate the user has recurring interest in the content of that site. Other factors, such as dwell time on a Web site or page, repeated click-throughs or selections of a Web site from search results over time, or other behavior or parameters may be captured and analyzed. When a candidate site or other content is identified, the user may be prompted to add that site to their set of browser favorites, or in embodiments may be automatically added according to user or default selection. According to embodiments in another regard, implicit favorites logic may likewise periodically or otherwise be applied to the set of favorites themselves, to for example delete obsolete or other entries. Because potential favorites are automatically sensed and offered for inclusion, users may be less likely to lose track or misidentify Web sites or other content they may later wish to access.

### CROSS-REFERENCE TO RELATED APPLICATION

Not applicable.

### STATEMENT REGARDING FEDERALLY SPONSORED RESEARCH OR DEVELOPMENT

Not applicable.

### FIELD OF THE INVENTION

The invention relates to the field of computerized information retrieval, and more particularly to a system and method which automatically senses Web sites or other sources of potentially recurring interest to the user, and generates additions or modifications to the user's browser favorites based on that detection logic.

### BACKGROUND OF THE INVENTION

Internet browsing continues to be a significant component of many user's computer usage and experience. Users who frequently return to a Web site or other source, who wish to explore a site at a later time, or otherwise wish to bookmark or store a Web site or other location often record that site in their “favorites” folder, which in many browsers consists of a list or directory of Web sites, URLs (universal resource indicators) and other information related to locations of interest. The user may then simply invoke a drop-down or other menu of those favorites to quickly navigate back to those sites at later times.

However, in the course of searching or browsing activity many users may pursue one link or location after another when investigating information of interest, and not be able to readily recall a site they had visited which might be of interest later. Other users may not realize that a Web site or other location they had visited might turn out to be useful at a later time. Still other users may believe they can recall important URLs or other addresses, or not wish to interrupt their browsing workflow to manually enter a site into the favorites list, only to forget those sources later. Other problems in site management and browsing technology exist.

### SUMMARY OF THE INVENTION

The invention overcoming these and other problems in the art relates in one regard to a system and method for automatic generation of browsing favorites, in which a user's Web or other navigation activity may be monitored by an implicit favorites logic module configured with rule sets designed to infer or detect Web sites or other locations or content which may form likely candidates to be added to the user's “favorites” folder or store. According to embodiments of the invention in one regard, the implicit favorites logic may capture user behavior such as frequency or length of visits to Web sites or other locations, detection of repeated click-throughs from search results, type or amount of data entered into a Web site or other location, or other data or parameters which may suggest that a user finds a site to be of potentially recurring interest. According to embodiments of the invention in one regard, the user may be queried to add the candidate Web or other site or content, or in other embodiments may configure the favorites to automatically enter candidate sites into their set of favorites, in a temporary or permanent place. Because users are automatically prompted or given Web sites for addition to stored favorites without having to back track or recall navigation activity, users may in many cases capture a richer or more complete set of favorites for future use.

### BRIEF DESCRIPTION OF THE DRAWINGS

FIG. 1 illustrates an overall environment in which a system and method for automatic generation of browsing favorites may operate, according to embodiments of the invention.

FIG. 2 illustrates an overall environment in which a system and method for automatic generation of browsing favorites may operate, according to embodiments of the invention in another regard.

FIG. 3 illustrates an overall environment in which a system and method for automatic generation of browsing favorites may operate, according to embodiments of the invention in a further regard.

FIG. 4 illustrates a flowchart of overall automatic favorites management and processing, according to embodiments of the invention.

### DETAILED DESCRIPTION OF EMBODIMENTS

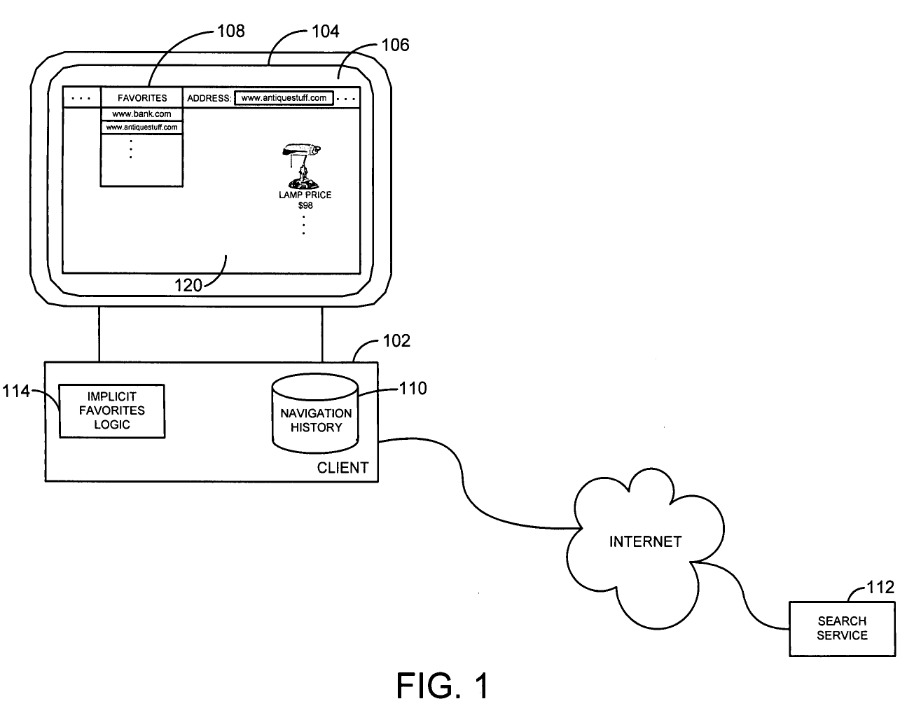

FIG. 1 illustrates an environment in which a system and method for automatic generation of browsing favorites may operate, according to embodiments of the invention. As illustrated in that figure a user may operate a client 102 such as a desktop or laptop computer, a network-enabled cellular telephone, wireless email client, or other client, machine or device to perform various tasks including Web browsing, search and other tasks, applications and functions. The user may interact with those resources via a user interface 104, such as a graphical user interface, command-line user interface, voice-recognition interface or other interface, for example to navigate to Web page 106, such as an Internet or other public or private page, address or location. According to embodiments, the Web page 106 may be accessed by direct inputting of universal resource locators (URLs), by selection of search results from search service 112, by selection of favorites 108, or navigated by other locators, addresses, interfaces or identifiers. Favorites 108 may be or include a set of stored Web sites, addresses, URLs or other identifiers which may, for example, be accessible by or stored within a Web browser 120 or other application or resource.

According to embodiments of the invention in a further regard, client 102 and/or applications residing thereon may host implicit favorites logic 114, for detecting and managing potential Web sites or other locations, sites or content to add to the user's favorites 108. Implicit favorites logic 114 may as illustrated communicate with navigation history 110, which may contain a data store of the user's browsing and navigation history, for example to record addresses of current or past Web sites or other locations navigated or visited, times or frequencies of those visits, or other browsing, searching or other activity or behavior for purposes of identifying potential additions or modifications to favorites 108.

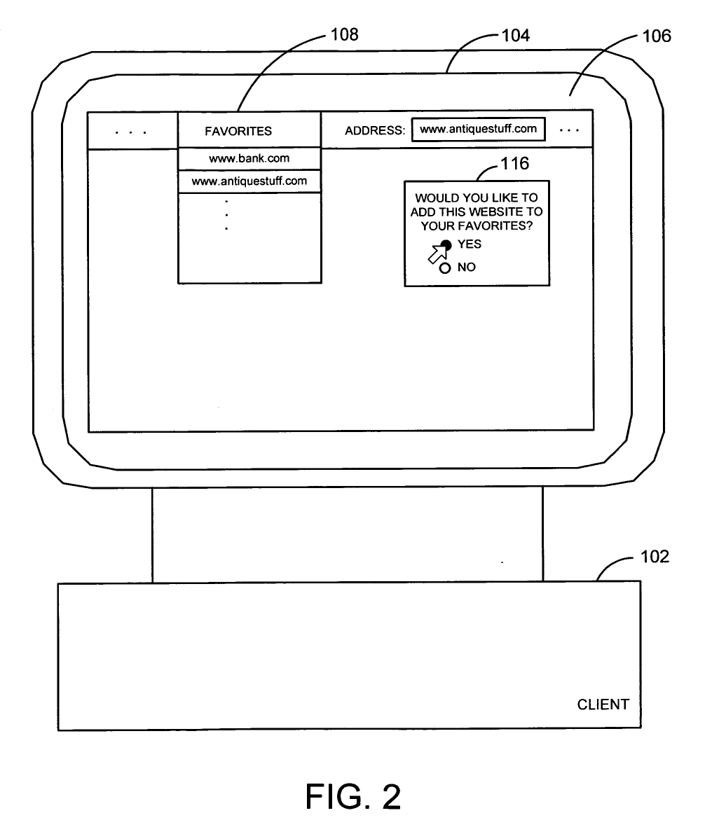

In general, according to embodiments of the invention and as illustrated in FIG. 2, upon identification of potential Web sites or other locations or content for addition to favorites 108, the implicit favorites logic 114 may generate or display a set of selectable favorites options 116, for instance to notify the user that a Web site has been detected which may form a candidate for addition, and prompt the user to add that site to favorites 108. According to embodiments of the invention in another regard, the user may configure selectable favorites options 116 to automatically accept and register new candidates to favorites 108 without prompting, or to automatically register new candidates to selected folders, which folders may be selected on an automatic or manual basis. Other options, selections and configurations are possible.

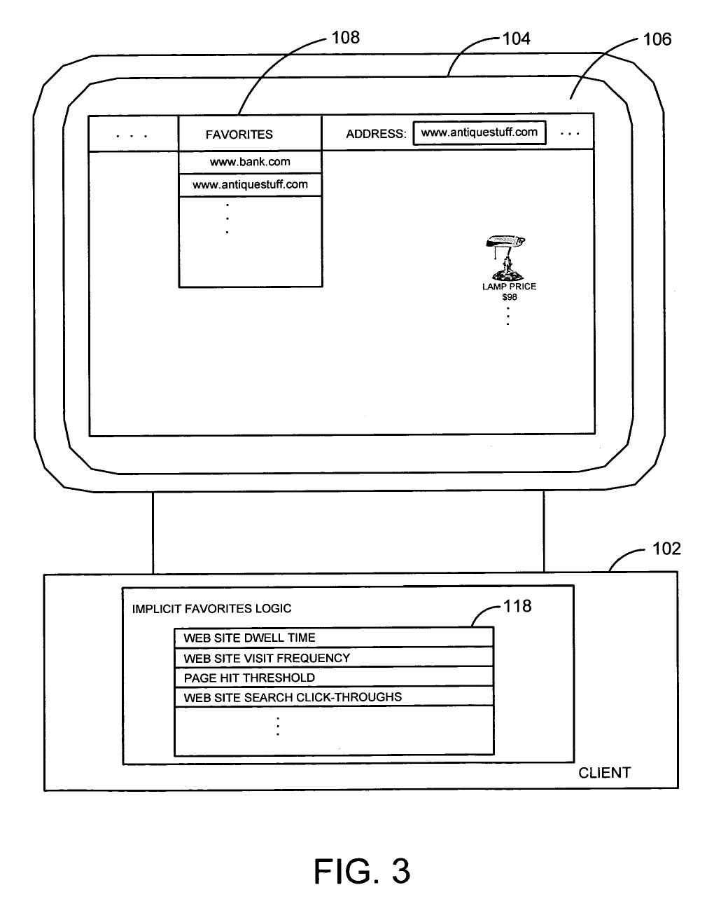

According to embodiments of the invention in another aspect, and as for example illustrated in FIG. 3, the implicit favorites logic 114 may access a set of predictive factors 118 to analyze the user's browsing, search or other behavior to identify potential additions or modifications to favorites 108. The set of predictive factors 118 may include, for example, factors, variables or parameters such as Web site dwell time, Web site visit frequency, a page hit threshold, Web site click-through or other selection via search results, or other factors, variables or parameters. The set of predictive factors 118 may be extensible, and in embodiments may for example be updated by downloads, or otherwise. According to embodiments of the invention in a further regard, the implicit favorites logic 114 may generate a dialog to query the user about the perceived accuracy or satisfaction with potential additions to favorites 108. When employed this type of explicit user feedback may be incorporated in implicit favorites logic 114, set of predictive factors 118 or other resources.

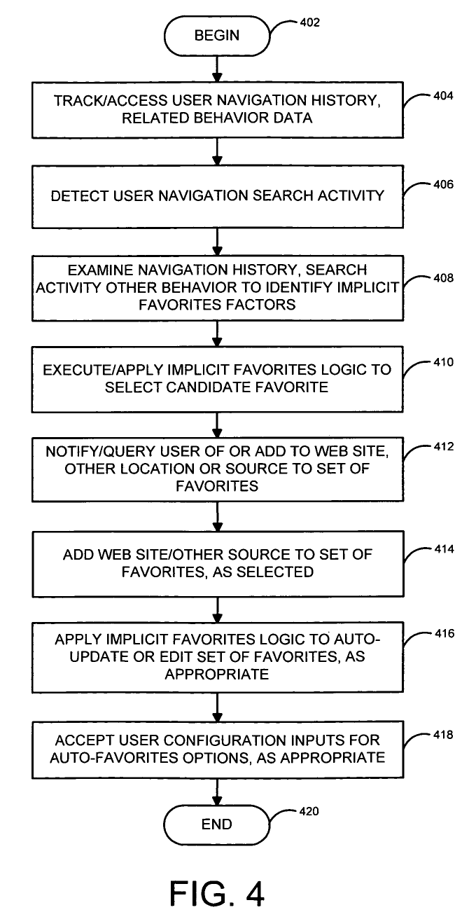

FIG. 4 illustrates overall automatic favorites management processing, according to embodiments of the invention. In step 402, processing may begin. In step 404, implicit favorites logic 114 may track or access the user's navigation and/or query history, along with other user behavior data. In step 406, the implicit favorites logic 114 may detect user browsing, navigation, search or other activity. In step 408, the implicit favorites logic 114 may examine the user's navigation history 110 including any search activity to identify implicit favorites factors 118 such as, for example, dwell time on a Web or other site, a Web site visit frequency, a page hit threshold, the occurrence or frequency of Web site search click-throughs directed to a subject site, or other factors, parameters or data. In step 410, implicit favorites logic 114 may execute or apply those or other rules, heuristics, thresholds or other criteria to select or identify Web sites or other locations or content for addition or inclusion in favorites 108.

In step 412, the user may be notified or queried to add the candidate Web site or other location or source to favorites 108, for instance by dialog box or other query exchange. In step 414, the candidate Web site or other source or content may be added to favorites 108, as selected by the user. In step 416, implicit favorites logic 114 may periodically or when manually activated examine or analyze the set of favorites 108, to automatically update the set of sites, locations or content in that set. For example, Web sites which have not been visited in 90 days or other time period may be automatically removed or prompted for removal. Other editing or processing of favorites 108 is possible.

In step 418, the implicit favorites logic 114 may accept user configuration inputs for automatic favorites options or selections, for instance to turn automatic favorites on or off on a per-session, per-site, permanent or other basis. In step 420, processing may repeat, return to a prior processing point, jump to a further processing point or end.

The foregoing description of the invention is illustrative, and modifications in configuration and implementation will occur to persons skilled in the art. For instance, while the invention has generally been described in terms of a user accessing one search service 112 or accessing other single Web locations, in embodiments potential favorites may be accessed from multiple Web sites, more than one search engine or service, or other content or locations, including for example local area networks or other public or private, local or remote resources.

Similarly, while the invention has in embodiments been described as involving analysis of navigation history 110 tied to a single user, in embodiments aggregate usages patterns may also be used to configure rules or thresholds for implicit favorites logic 114 and candidate favorites. Other hardware, software or other resources described as singular may in embodiments be distributed, and similarly in embodiments resources described as distributed may be combined. The scope of the invention is accordingly intended to be limited only by the following claims.

We claim:

1. A system for automatically generating browsing favorites, comprising:
an interface to receive user navigation data from browsing activity; and
an implicit favorites engine, the implicit favorites engine communicating with the interface to receive the user navigation data and identify potential additions to a set of favorites based on the user navigation data and a set of implicit favorites factors.

2. A system according to claim 1, wherein the browsing activity comprises at least one of Web browsing, search navigation and private network browsing.

3. A system according to claim 1, wherein the user navigation data comprises at least Web site location data and search results selection data.

4. A system according to claim 1, wherein the potential additions are presented to the user for selection via a dialog interface.

5. A system according to claim 1, wherein the potential additions are automatically added to the set of favorites.

6. A system according to claim 1, wherein the set of implicit favorites factors comprises at least Web site dwell time data, Web site visit frequency data, page hit threshold data and search results selection data.

7. A system according to claim 1, wherein the implicit favorites engine accesses aggregate explicit favorites data to identify the potential additions.

8. A method for automatically generating browsing favorites, comprising:
receiving user navigation data from browsing activity; and
identifying potential additions to a set of favorites based on the user navigation data and a set of implicit favorites factors.

9. A method according to claim 8, wherein the browsing activity comprises at least one of Web browsing, search navigation and private network browsing.

10. A method according to claim 8, wherein the user navigation data comprises at least Web site location data and search results selection data.

11. A method according to claim 8, further comprising presenting the potential additions to the user for selection via a dialog interface.

12. A method according to claim 8, further comprising automatically adding the potential additions to the set of favorites.

13. A method according to claim 8, wherein the set of implicit favorites factors comprises at least Web site dwell time data, Web site visit frequency data, page hit threshold data and search results selection data.

14. A method according to claim 8, further comprising accessing aggregate explicit favorites data to identify the potential additions.

15. An automatically generated addition to a set of browsing favorites, the automatically generated addition being generated by a method comprising:
receiving user navigation data from browsing activity; and
identifying potential additions to a set of favorites based on the user navigation data and a set of implicit favorites factors.

16. An automatically generated addition according to claim 15, wherein the browsing activity comprises at least one of Web browsing, search navigation and private network browsing.

17. An automatically generated addition according to claim 15, wherein the user navigation data comprises at least Web site location data and search results selection data.

18. An automatically generated addition according to claim 15, wherein the method further comprises presenting the potential additions to the user for selection via a dialog interface.

19. An automatically generated addition according to claim 15, wherein the method further comprises automatically adding the potential additions to the set of favorites.

20. An automatically generated addition according to claim 15, wherein the set of implicit favorites factors comprises at least Web site dwell time data, Web site visit frequency data, page hit threshold data and search results selection data.
